(19) United States
(12) Patent Application Publication
(10) Pub. No.: US 2013/0179289 A1
(43) Pub. Date: Jul. 11, 2013

(54) PRICING OF RESOURCES IN VIRTUAL MACHINE POOLS

(71) Applicants: BRADLEY GENE CALDER, Bellevue, WA (US); JU WANG, Redmond, WA (US); SRIRAM SANKARAN, Bellevue, WA (US); MARVIN McNETT, II, Redmond, WA (US); PRADEEP KUMAR GUNDA, Bellevue, WA (US); YANG ZHANG, Issaquah, WA (US); SHYAM ANTONY, Bellevue, WA (US); KAVITHA MANIVANNAN, Redmond, WA (US); ARILD E. SKJOLSVOLD, Kenmore, WA (US); HEMAL KHATRI, Redmond, WA (US)

(72) Inventors: BRADLEY GENE CALDER, Bellevue, WA (US); JU WANG, Redmond, WA (US); SRIRAM SANKARAN, Bellevue, WA (US); MARVIN McNETT, II, Redmond, WA (US); PRADEEP KUMAR GUNDA, Bellevue, WA (US); YANG ZHANG, Issaquah, WA (US); SHYAM ANTONY, Bellevue, WA (US); KAVITHA MANIVANNAN, Redmond, WA (US); ARILD E. SKJOLSVOLD, Kenmore, WA (US); HEMAL KHATRI, Redmond, WA (US)

(73) Assignee: MICROSOFT CORPORTAION, Redmond, WA (US)

(21) Appl. No.: 13/346,375

(22) Filed: Jan. 9, 2012

(51) Int. Cl. G06Q 30/06

(52) U.S. Cl. 705/26.3

(57) ABSTRACT

Systems and methods are provided for assigning resources in a cloud computing environment via a spot pricing process. The spot pricing process allows virtual machines to be assigned on a preemptible basis to pools based on bids associated with the pools. The bids can be used to determine a price for assignment of preemptible virtual machines. Preemptible virtual machines can then be assigned to pools based at least in part on the submitted bids in relation to the determined price.

### CROSS-REFERENCE TO RELATED APPLICATIONS

This application is related in subject matter to the following concurrently filed U.S. patent applications: U.S. patent application Ser. No. ______, entitled “PLATFORM AS A SERVICE JOB SCHEDULING,” having attorney docket number MFCP.164011; U.S. patent application Ser. No. ______, entitled “DECOUPLING PAAS RESOURCES, JOBS, AND SCHEDULING,” having attorney docket number MFCP.165406; U.S. patent application Ser. No. ______, entitled “ASSIGNMENT OF RESOURCES IN VIRTUAL MACHINE POOLS,” having attorney docket number MFCP.165407; and, U.S. patent application Ser. No. ______, entitled “PAAS HIERARCHIAL SCHEDULING AND AUTO-SCALING,” having attorney docket number MFCP.165409; the entirety of the aforementioned applications are incorporated by reference herein.

### BACKGROUND

Conventional methods for performing large scale computational jobs often involved a user purchase of computer hardware to serve as a computing platform. This can lead to variety of inefficiencies, as many typical users have a peak level of computing need that differs from the routine need for computing resources. Purchasing sufficient hardware to meet peak resource needs can lead to low usage of computing resources. Alternatively, matching hardware to routine usage level can cause some desired computations to be impractical. More recently, improvements in processing speed and network transmission speed have made cloud computing environments a viable alternative to local computing platforms.

### SUMMARY

In various embodiments, systems and methods are provided for assigning resources in a cloud computing environment via a spot pricing process. The spot pricing process allows virtual machines to be assigned on a preemptible basis to pools based on bids associated with the pools. The bids can be used to determine a price for assignment of preemptible virtual machines. Preemptible virtual machines can then be assigned to pools based at least in part on the submitted bids in relation to the determined price.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

The invention is described in detail below with reference to the attached drawing figures, wherein:

FIG. 1 schematically shows an example of a system or component suitable for use in implementing a cloud computing environment.

FIG. 2 schematically shows an example of a system or component suitable for use in implementing a cloud computing environment.

FIG. 3 schematically shows an example of a system or component suitable for use in implementing a cloud computing environment.

FIG. 4 schematically shows an example of a system or component suitable for use in implementing a cloud computing environment.

FIG. 5 schematically shows an example of a system or component suitable for use in implementing a cloud computing environment.

FIG. 6 schematically shows an example of a system or component suitable for use in implementing a cloud computing environment.

FIGS. 7-11 schematically show examples of managing virtual machines in a cloud computing environment in accordance with an embodiment of the invention.

FIG. 12 schematically shows a computing device suitable for performing embodiments of the invention.

FIGS. 13-15 show examples of process flows according to the invention.

### DETAILED DESCRIPTION

### Overview

Due to increases in the speed of data transmission over networks and improvements in other network features, it is increasingly possible to perform large scale computing tasks in an environment where computing resources are distributed over a large network. A user in a first location can submit a job or computing task to a computing service and have the task performed on a group of computers that the user has no direct knowledge of. The computing resources for performing the user's task may be distributed over multiple locations. A first group of computing resources located in one or more locations can store the data and other information for performing the user's computing task, while a second group of computing resources, in the same locations or possibly in a different set of one or more locations, can be used to perform the computing task.

Access to a variety of distributed computing resources allows a user to perform job tasks without concern for where the computing resources are located. The distributed resources also provide an opportunity for a user to scale out (or scale in) the amount of resources used in order to meet goals for a computing task, such as completing the computing task by a specified time. However, providing this flexibility for the user poses a number of challenges for the operator (or owner) of the distributed computing resources. In order to meet demand, the operator of a distributed network of resources will preferably have sufficient available resources to satisfy resource requests at times of peak demand.

A cloud computing environment with sufficient resources at peak demand will likely have excess virtual machines available at least during non-peak demand periods, and possibly at all times. The excess virtual machines can represent a reserve of virtual machines to allow scale-out of jobs based on user requests, a reserve of virtual machines to compensate for resource failures, or simply virtual machines that are used during peak demand but not needed as dedicated resources at non-peak times. Rather than allowing these resources to be idle, an auction mechanism can be used to allow users to bid for temporary access to the excess virtual machines. This provides customers with access to machines at a lower cost while allowing a cloud computing operator to maximize the value of the resources needed to meet peak demand and/or system redundancy requirements.

### Definitions

An “account” is a global uniquely identified entity within the cloud computing environment. In an embodiment, all of the resources and tasks discussed below are scoped within an account. Typically, a user will create an account first before using the resources of a cloud computing system. After creating the account, the user can use the account to submit work items to the system and manage resources for performing jobs based on the work items.

A “work item” is a static representation of a job to be run in the cloud computing environment. A work item can specify various aspects of a job, including job binaries, pointers to the data to be processed, and optionally the command line to launch tasks for performing the job. In addition, a work item may specify the reoccurrence schedule, priority and constraints. For example, a work item can specify to be launched every day at 5 PM.

A “job” is a running instance of a work item. A job contains a collection of tasks that work together to perform a distributed computation. The tasks can run on one or more virtual machines in the cloud computing environment.

A “task” is the fundamental execution unit of a job. Each task runs on a virtual machine. Users can specify additional input to the command line and pointers to input data for each task. A task may create a hierarchy of files under its working directory on the virtual machine performing the task during the course of execution of the task.

A “job manager task” (JM task) is a special task in a job. A job manager task is optional, so some jobs can be performed without the use of a JM task. A job manager task provides a single control point for all of the tasks within a job and can be used as the “master” task for the job. If a job has a JM task, the system launches the JM task as the first task in the job. The JM task can then submit more tasks to the job, and it can monitor the progress of these tasks and control when to submit the next batch of tasks. In this way, the JM task can coordinate the scheduling of all the tasks in a job and manage dependencies among tasks. Preferably, if the node or virtual machine for the job manager task fails, the JM task is restarted automatically on another virtual machine so that the JM task is always running for the corresponding job. In addition, users can specify to the system that once the JM task completes, the system can terminate all the tasks in the corresponding job.

### Virtual Machine Pools and Task Tenants

A virtual machine refers to a logical unit of processing capability. A virtual machine can have a one to one correspondence with a physical processor, or a virtual machine can correspond to a plurality of processors, or a virtual machine can represent a percentage of processing time on one or more processors. A virtual machine assigned to a pool can perform one or more tasks for the pool at any given time.

In various embodiments, the virtual machines that may potentially perform a job based on a work item are associated with the account for the work item prior to use. A “pool” is a logical grouping of virtual machines. A work item always has at least one associated pool to run the job(s) corresponding to the work item. Each account can create one or more pools to which the account gets access for use in performing work items associated with the account. Typically an account has exclusive access to pools associated with the account. A pool can be created when a work item is submitted by a user, or a work item can be associated with an existing pool. A pool may be created automatically by the system to perform a job. For example, a reoccurring work item that runs at a specific time each day can be handled by having a pool automatically created to perform the job at the start time. The pool can be deleted each day after completing the reoccurring work item. Optionally, a pool can be associated for use with a single work item, a single job, or another subset of the work items corresponding to an account.

When a work item is submitted by a user, the work item can be associated with one or more pools of virtual machines. The virtual machines can be organized within a pool in any convenient manner. For example, all virtual machines can be organized in a single pool regardless of the geographic location of the underlying processor for the virtual machine. Another option is to organize virtual machines based on geographic location, so that all virtual machines for a pool are in a given geographic location. Still another option is to organize virtual machines on a basis other than geographic location, such as proximity to other variables (e.g., storage resources, network latencies, user location/preference, security requirements). Yet another option is to automatically create a pool when a work item or job is created, and then tear down the pool with the work item or job is finished.

Virtual machine pools represent one method for organizing virtual machines. Another organizational unit for virtual machines is a virtual machine cluster. A virtual machine cluster represents a group of virtual machines that are managed together by a process in the cloud environment, such as a task tenant process. The virtual machines in a virtual machine cluster can correspond to physical machines that are grouped together in a convenient manner. For example, a virtual machine cluster can correspond to a group of physical machines that are located in the same geographic region, such as in the United States or in a northeast portion of the United States; in the same general location, such as in a city or metropolitan area like Seattle or San Diego County; or in the same specific location, such as in one or more connected or nearby buildings that form a computing or data center. Another option is to form a virtual machine cluster based on a group of physical machines that have a favorable data transfer rate with a specified portion of storage in the cloud environment. Still another option is to form multiple virtual machine clusters based on the physical machines at a given location. A virtual machine pool can span across a plurality of virtual machine clusters. A process for managing a virtual machine cluster, such as a task tenant, can assign and unassign virtual machines from a virtual machine pool. A task tenant (or other process for managing a virtual machine cluster) can also schedule tasks on a virtual machine within a cluster based on a queue of jobs corresponding to the pool the virtual machine is assigned to. When a task tenant needs additional machines in order to assign a sufficient number to a virtual machine pool, the task tenant can obtain additional virtual machines from the general cloud computing environment. Similarly, if a task tenant has an excess of virtual machines, the task tenant can return the excess machines to the general cloud computing environment.

### Dedicated, Standby, and Preemptible Machines

When a virtual machine is assigned to a pool, the virtual machine can be assigned as one of two types. The virtual machine can be assigned to the pool as a dedicated virtual machine or a preemptible virtual machine. The status of a virtual machine as dedicated or preemptible can also change while the virtual machine is in the pool.

A “dedicated” virtual machine is a machine assigned to a pool for dedicated use by work items or jobs assigned to the pool. Optionally, a dedicated virtual machine may be assigned for dedicated use for one or more associated work items, as opposed to being generally available for any job submitted to the pool. While a virtual machine has a dedicated status, the machine is reserved for use by the account associated with the pool. A dedicated machine is not provisioned with resources from other accounts and does not perform jobs on behalf of other accounts.

A “preemptible” virtual machine is a virtual machine that is currently performing a task in a pool on behalf of an account, but without a guarantee that the virtual machine will continue to be available for that pool. When a preemptible virtual machine is made available to a pool, the preemptible machine is added to that pool. The preemptible machine is then provisioned and used to perform a job for that pool. The preemptible machine can be made available to the pool by any convenient method, such as by having the pool (on behalf of the corresponding account) win processing time on the preemptible virtual machine in a resource auction.

An additional factor in assigning dedicated and preemptible virtual machines is whether the request for the virtual machine includes an affinity for a particular virtual machine cluster. An affinity for a virtual machine cluster can be based on a variety of reasons. One example of a request for affinity to a virtual machine cluster is due to a desire or need to have a virtual machine with improved access (such as high data transfer speeds) to data storage for a job that will be performed on a virtual machine. For this type of storage affinity, the affinity request can specify assignment of virtual machines from one or more virtual machine clusters that have the desired access to data. This can represent, for example, a group of virtual machines that correspond to physical machines that have a desired physical data connection to a data storage center. Another type of affinity is job affinity. Some types of jobs performed by virtual machines can involve substantial amounts of communication between virtual machines working on the same or a similar job. In a job affinity situation, it can be beneficial to have all virtual machines working on a job to be located within a single virtual machine cluster (or other virtual machine organizational unit), in order to facilitate message passing between the virtual machines. Selecting virtual machines from a single virtual machine cluster can correspond to selecting virtual machines that correspond to physical machines in the same geographic location.

A virtual machine made available for use to an account as a preemptible virtual machine will typically be a virtual machine that has another purpose in the cloud computing environment. For example, one source of preemptible virtual machines are virtual machines provisioned by the cloud computing environment owner/operator for disaster recovery purposes. In order to provide stable operation, a cloud computing environment may include one or more groups virtual machines that are held in reserve. These reserve virtual machines are available to replace resources that are lost due to a processor failure, network failure, or any other kind of event that results in a portion of the cloud environment being no longer suitable for performing jobs. When one or more dedicated virtual machines assigned to a pool are lost due to an event, the lost machines can be replaced using the reserve virtual machines. This improves the availability of resources in the cloud computing environment. However, since it is desirable for failure events to be rare, having a reserve of disaster recovery machines will often mean that a large number of virtual machines are sitting idle waiting to be used. Rather than wasting the CPU cycles of these virtual machines designated for handling failure events, the CPU cycles of these virtual machines can be assigned to pools as preemptible virtual machines to run work items or jobs. If a failure occurs, and the system needs to take preemptible resources away to fill the requirements of dedicated resources, a preemptible job running on such a virtual machine will be stopped as soon as is feasible (and possibly immediately) so that the preemptible virtual machine can be used for its original purpose of replacing a lost or failed resource.

Another source of preemptible machines is excess capacity virtual machines. Typically, the peak load of any network will be different from the average load. As a result, a computing environment with sufficient resources to handle a peak load situation will often have excess resources available during other times. These excess resources provide a resource cushion. When a user makes a request for additional dedicated virtual machines, the excess virtual machines can be used to fulfill the user's request. When the cloud computing environment has a load that is less than the peak load for dedicated machines, one or more virtual machines will be free. Rather than wasting the CPU cycles of these virtual machines designated for providing spare capacity, the CPU cycles of these virtual machines can be assigned to users and pools on a preemptible basis. As the load of requests for dedicated virtual machines increases, preemptible jobs running on these excess virtual machines will be stopped as soon as is feasible (and possibly immediately). This allows the preemptible virtual machine to be used for its original purpose of providing additional dedicated resources when needed. Additionally or alternately, some increases in the load for dedicated machines will be due to scheduled requests for dedicated machines. If a virtual machine is going to become unavailable due to use as a dedicated machine at a scheduled time, a preemptible job assigned to the virtual machine may be stopped prior to the scheduled time to allow for an orderly transition from the preemptible job to the dedicated resources.

In some situations, a user may desired to have access to a larger number of dedicated machines at some future time. In this situation, a user can reserve one or more virtual machines as standby virtual machines. A “standby reservation of virtual machines is a reservation associated with a pool or account for virtual machines to be assigned to the pool or account for use at some point in the future. Provisioning the virtual machine for use can mean merely that sufficient virtual machine resources are identified and/or reserved within the cloud computing environment, so that virtual machine resources will be available for conversion to dedicated virtual machines when requested. Optionally, provisioning the standby machine can also include provisioning the virtual machine with data, executables, or a combination thereof.

A standby virtual machine reservation is not an allocation or assignment of a virtual machine. Instead, a standby virtual machine reservation reserves the right in the future for an idle or preemptible virtual machine to be converted to a dedicated virtual machine assigned to the user or pool associated with the standby reservation. The preemptible job can be a job associated with the pool or account associated with the standby reservation, another different pool, or another different account. When a standby reservation is made by a pool or account, a virtual machine from a virtual machine cluster is not assigned to the pool or account. Instead, a count is kept of the number of standby reservations corresponding to the virtual machine cluster, so that a sufficient number of idle or preemptible virtual machines are available to satisfy the standby reservations corresponding to the virtual machine cluster.

A virtual machine standby reservation can be associated with a pool for a variety of reasons. One use for standby machine reservations is for users that have high priority computation jobs that occur only during a specific time frame. For example, a financial company may wish to perform analysis of the daily activity of one or more financial markets, such as a stock exchange or a commodities exchange. The financial markets open and close on a defined schedule, such as opening at 9:30 AM and closing at 4:00 PM. The financial company would like to aggregate data from the hours the financial markets are open for use in performing analysis or simulations. The goal of the analysis is to provide information for their employees before the markets open the following day. Such analysis can require a large number of virtual machines, but the virtual machines are needed only between the hours of, for example, from 6:00 PM until 3:30 AM the following morning. During this time the financial company desires a guarantee of availability of the virtual machines. During the rest of the day, the financial company does not need the machines. Associating virtual machine reservations with the account of the financial company can achieve this goal. In exchange for paying a reservation price, the financial company is guaranteed the availability of the machines during the desired times. Outside of the desired time window, the virtual machines can be used as preemptible machines for the financial company and/or other users.

Standby reservations can be used to convert idle or preemptible virtual machines to dedicated machines assigned to a pool corresponding to a user based on time-based criteria or load-based criteria. In some situations, a standby reservation can cause conversion of an idle or preemptible virtual machine to a dedicated virtual machine based at least in part on a predetermined time and/or date. In such a situation, a preemptible virtual machine being converted to a dedicated virtual machine based on the standby reservation can be stopped in an orderly manner prior to the scheduled availability event. This is defined as a standby reservation having time-based criteria. Time-based criteria are in contrast to load-based criteria which are used to define a load-based threshold. A load-based threshold corresponds to a threshold based on usage and/or performance of one or more cloud resources. Preferably, a load-based threshold excludes the use of a time-based criteria. In addition to time-based criteria and load-based criteria, still another option for converting one or more virtual machines corresponding to a standby reservation to dedicated virtual machines is based on a request from a user or a system administrator.

Another use for a standby reservation is to allow for improved performance when scaling out a job. For example, a retail store may use cloud computing resources to handle additional on-line traffic during the shopping season in advance of a holiday, such as on-line traffic for reviewing the retailer's website and placing orders. Based on past experience, the retailer expects a certain level of on-line activity, and reserves a corresponding number of dedicated virtual machines. However, in the event that on-line activity is greater than expected, the retailer also reserves additional machines via a standby reservation. The retailer can then set up one or more thresholds that indicate a higher than expected level of activity. As these thresholds occur, the standby reservation can be used to convert idle or preemptible virtual machines to dedicated machines to allow the retailer to handle the additional on-line traffic without having the customers of the retailer experience slow response times. In this situation, a standby reservation may be converted to a dedicated machine at an unpredictable time, as it may not be known when an activity threshold will be satisfied. When an activity threshold is met, idle or preemptible virtual machines are converted to dedicated virtual machines assigned to a pool associated with the standby reservation. If a preemptible task is running on the virtual machine prior to conversion, the preemptible task is stopped prior to converting the virtual machine to a dedicated machine. Optionally, the activity threshold does not include a time-based criteria.

### Assigning Preemptible Machines Based on Spot Pricing

Any virtual machines within the cloud computing environment that are not associated with a pool as a dedicated machine are potentially available for assignment via spot pricing. Thus, the virtual machines available for assignment via spot pricing can include virtual machines currently running a preemptible job, virtual machines for use in disaster recovery, and any other excess or idle virtual machines. The excess or idle virtual machines available for assignment as preemptible virtual machines can include idle virtual machines that are needed to satisfy the standby reservation count for a virtual machine cluster.

In order to obtain a virtual machine via spot pricing, a specification for a pool associated with an account can include a specification of a number of preemptible virtual machines that are desired. The specification will typically further include a bid or price that the user of the account is willing to pay in order to obtain one or more preemptible virtual machines. The specification for the pool is not limited in the number of bids. For example, a pool specification could include a sliding scale of bids, where a first (higher) bid is provided to obtain two preemptible virtual machines, a second (mid-range) bid is provided to obtain three additional preemptible virtual machines, and a third (lower) bid is provided to obtain a final two preemptible virtual machines. Depending on the spot price, such a bid pattern could lead to a user being assigned zero, two, five, or seven preemptible virtual machines.

Assignment of preemptible machines via spot pricing can take place periodically, with each assignment resulting in assignment of preemptible machines for an assignment time period. Preferably, assignment time periods can be consecutive, so that the end of one assignment time period corresponds to the beginning of the next assignment time period. Typically, the spot price is recalculated at or near the beginning of each assignment time period. The spot price remains unchanged during an assignment time period.

A pool can submit a bid for preemptible virtual machines at any time. However, there is no guarantee that a bid above the spot price will immediately result in assignment of a preemptible machine based on the bid. If the pool has submitted a bid above the spot price and sufficient virtual machines are available, the preemptible virtual machines requested will be assigned no later than the beginning of the next assignment time period. If the bid for preemptible virtual machines is submitted during an assignment time period, machines may be assigned immediately, but only if excess virtual machines are available. In particular, a pool with a lower bid may already have a preemptible virtual machine assigned. A higher bid from another pool may displace the lower bid at the beginning of an assignment time period, but not at an intermediate time. An account that is assigned a preemptible virtual machine will only lose the virtual machine during the middle portion of an assignment time period due to the virtual machine being required for a non-preemptible purpose, such as conversion to a dedicated machine or use as a disaster recovery machine.

The length of the assignment time periods can be set to any convenient value. For example, an assignment time period can be at least about 15 minutes, or at least about 30 minutes, or another convenient interval. Optionally, the assignment time period can vary throughout the course of a day if desired, or the time period can vary on weekdays versus weekends, or any other variance in the period can be introduced. Preferably, the assignment time periods can start at predetermined times, such as every half hour.

One option for determining a spot price for preemptible virtual machines is to determine a global spot price. To determine a global spot price, the bids from all machine pools within a cloud computing environment are aggregated. The spot price is then compared with the total number of virtual machines available at the beginning of an assignment time period. The spot price can then be set as the global price necessary to assign preemptible machines for at least all bids greater than the spot price. If a large number of bids are at the break point for assigning machines, so that the bids at the spot price would only be partially satisfied, the bids at the market clearing price can be handled in any convenient manner. For example, the spot price can be set at the next highest bid, so that all bids at or greater than the spot price are entitled to the requested number of preemptible machines. Alternatively, the spot price can be set equal to the market clearing price, with the bids at the market clearing price potentially receiving only a portion of the requested machines.

Although the spot price is set globally, the assignment of preemptible virtual machines is handled locally, such as at the task tenant level and/or group of virtual machine pool level. For example, the globally determined spot price can be distributed to the task tenants. The task tenants can then assign available virtual machines within each task tenant to the machine pools served by the task tenant. The assignments can start by fulfilling the highest bid from a pool within the task tenant, then fulfilling the next highest bid, and so on. This process can continue until no more bids above the spot price are available, or until no more virtual machines are available within the task tenant for assignment as preemptible virtual machines.

In some situations, the number of available preemptible virtual machine resources may change between the time the global price is calculated and the time assignment of preemptible virtual machines takes place. If this occurs, a virtual machine cluster (such as the machines managed by a task tenant) may not have sufficient virtual machines to assign preemptible virtual machines for all bids above the spot price. In this situation, the task tenant can optionally attempt to add more virtual machines. If any excess virtual machines are available within the cloud computing environment that are not associated with another task tenant, the excess virtual machines can be added and used to fulfill the additional requests for preemptible virtual machines with bids above the spot price. However, additional virtual machines suitable for incorporation into a given virtual machine cluster may not be available, such as due to lack of additional virtual machines with similar access to a storage area and/or that are in the same geographic location.

It is also possible that a task tenant will have more preemptible virtual machines than are needed to satisfy all bids greater than a spot price. Once again, preemptible virtual machines are assigned to virtual machine pools in order of the bids. After satisfying all bids higher than the spot price, the task tenant may still have additional preemptible virtual machines remaining. This can be an indication that the task tenant should return some virtual machines to the general cloud computing environment for reassignment to other task tenants. Even though additional preemptible virtual machines are available, bids below the spot price do not receive preemptible virtual machines.

After a preemptible virtual machine is assigned to a virtual machine pool, the preemptible virtual machine remains assigned to the pool until either the next auction, or until the virtual machine is needed for another purpose that preempts the current use. Examples of a use that preempts temporary use include the need to convert the virtual machine to a dedicated machine or the need to use the virtual machine for disaster recovery. When preemptible virtual machines are preempted, a task tenant can preempt suitable virtual machines in the order of lowest bid to highest bid. Another factor that can be considered in identifying a preemptible virtual machine for preemption is the length of time a job has been running on the preemptible virtual machine. A job that has just started is a better choice for preemption than a job that has been running for a multiple assignment time periods. This type of factor can be used, for example, as an additional consideration for preemptible jobs that were assigned based on the same bid value. In various embodiments, if a virtual machine assigned to an account is preempted during an assignment time period, the account is not charged for the assignment time period. However, if the preemptible virtual machine is voluntarily released during an assignment time period, the account is charged for the portion of the time period that was used.

### Example of Organization of Computing Resources in a Distributed Network Environment

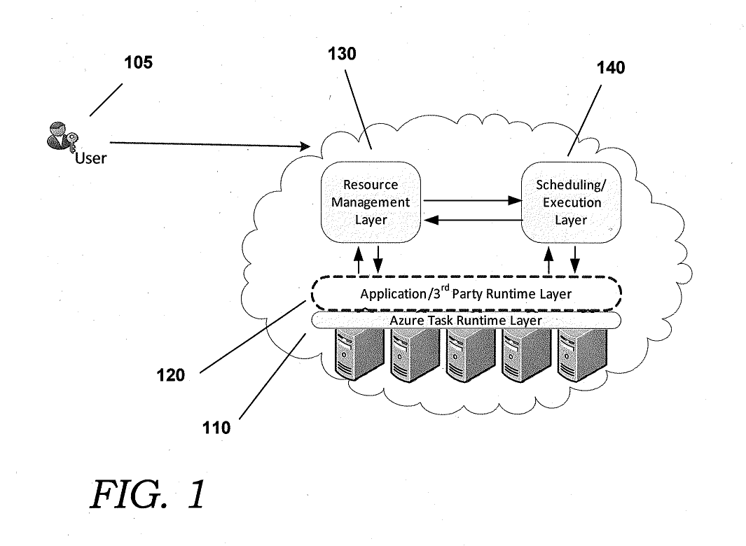

A user of a cloud computing environment will typically desire to perform jobs using the cloud computing resources. The jobs will typically involve performing jobs on data that is stored in locations that are accessible via the cloud computing environment. One way for an operator to provide a cloud computing environment is to provide the environment as a number of layers. FIG. 1 schematically shows an example of a system suitable for performing tasks within a cloud computing environment. The system in FIG. 1 includes a task runtime layer 110, a third party task runtime layer 120, a resource management layer 130, and a scheduling and execution layer 140.

In the embodiment shown in FIG. 1, the task runtime layer 110 is responsible for setting up the execution environment and security context for tasks from a user 105. The task runtime layer 110 can also launch tasks and monitor the status of the tasks. The task runtime layer 110 can take the form of a system agent running on each virtual machine. The task runtime layer may also include a runtime library that can be linked into a users' task executables. Having runtime libraries as part of the task runtime layer 110 can potentially provide richer capability to tasks executed by the system agent. Examples of runtime libraries include one or more efficient communication libraries to allow fast communication among tasks; an efficient remote file access library support to read files from other virtual machines and/or other tasks; a checkpoint library to allow tasks to checkpoint (e.g. into binary large objects) and resume; a logging library; and a library for providing a distributed file system to be used across virtual machines performing a given task within a pool of virtual machines.

The third party task runtime layer 120 allows additional runtimes to be built and run on top of task runtime layer 110. The third party task runtime layer 120 also can provide additional capabilities for coordinating the running of tasks for a job. Examples may include a MapReduce runtime to a library for providing a distributed file system to be used across virtual machines performing a given task within a pool of virtual machines. This allows a user to organize the cloud computing environment in a manner tailored for the user's jobs or tasks. In some embodiments, a job manager task can facilitate allowing a user to use a third party runtime layer to run and/or control cloud computing resources.

Resource management layer 130 deals with managing the computing resources available in the cloud computing environment. One option is to have the resource management layer 130 manage the resources at three different levels. At a first level, the resource management layer 130 manages the allocation and deallocation of virtual machines associated with a job (i.e., execution of a work item) as well as the files stored on each virtual machine associated with a task. At a second level, the virtual machines associated with a job can be grouped into pools of machines. A pool can contain virtual machines associated with one or more jobs and/or work items. Depending on the embodiment, a single pool can span across multiple virtual machine clusters, such as all virtual machine clusters in a data center, a plurality of virtual machine clusters across a plurality of data centers within a geographic region, or a plurality of virtual machine clusters across data centers in a plurality of geographic regions. A single pool can contain a large number of virtual machines, such as millions. The virtual machines can be contained in a large number of pools, such as up to billions. At a third level, the resource management layer manages the amount of virtual machines available for association with jobs or work items in a given group of pools. This allows for dynamic adjustment of the amount of compute resources used based on the current load of the system. Additionally, virtual machines that are not being used by a current group of pools may be released back to the cloud computing environment for incorporation into other groups of pools.

In the embodiment shown in FIG. 1, scheduling and execution layer 140 manages work items, jobs, and tasks that are being performed by a user. The scheduling and execution layer 140 makes scheduling decisions and is responsible for launching jobs and tasks as well as retries on failures. Such a scheduling and execution layer 140 can include components for managing jobs and/or tasks at various levels.

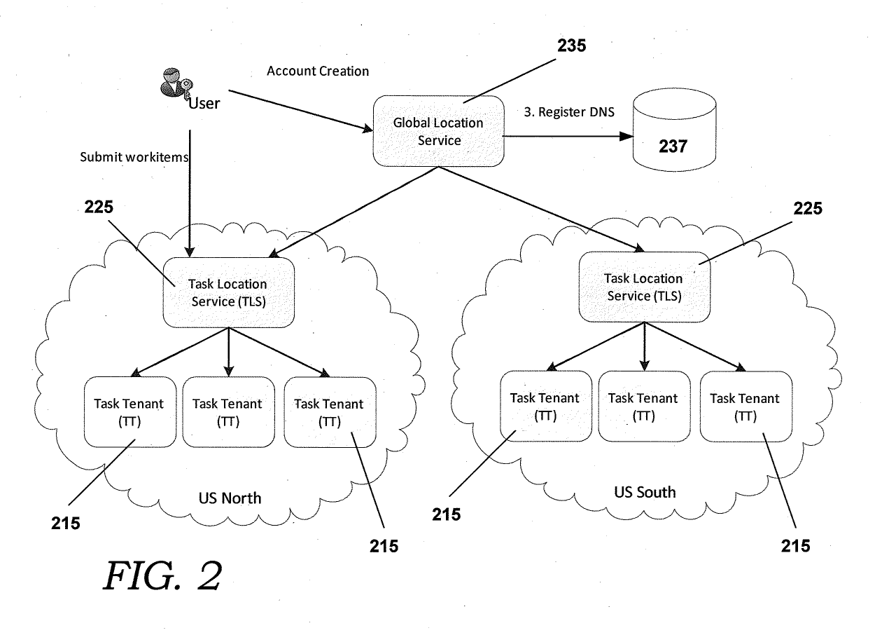

The layers described above can be implemented in a cloud computing environment that includes processors at multiple geographic locations. FIG. 2 schematically shows an example of how processors at different locations can be integrated within a single cloud computing architecture.

In FIG. 2, one or more task tenants 215 can be used to manage pools of virtual machines. A task tenant 215 can maintain a set of virtual machines. The jobs of one or more users can run on the virtual machines within a task tenant 215 as part of one or more pools of virtual machines. One or more task tenants 215 can be used in a given geographic region. The responsibilities of a task tenant 215 can include maintaining the set of virtual machines and dynamically growing or shrink the task tenant based on the resource utilization within the task tenant. This allows a task tenant 215 to increase the number of virtual machines within the task tenant to accommodate increased customer demand. This also allows a task tenant 215 to release unused virtual machines so that the virtual machines can be allocated to other hosted services in the data center handling service for other customers. Another responsibility of a task tenant 215 can be implementing part of the pool allocation/deallocation/management logic. This allows the task tenant 215 to participate in determining how virtual machines are assigned to pools associated with a task for a customer. The task tenant 215 can also be responsible for scheduling and execution of tasks on the virtual machines within the task tenant.

In the embodiment shown in FIG. 2, one or more task location services 225 are provided that control a plurality of task tenants 215. The plurality of task tenants can correspond to all task tenants in a given geographic region, various task tenants from around the world, or any other convenient grouping of task tenants. In FIG. 2, task location services 225 are shown that serve regions labeled “US North” and US South”. The responsibilities of a task location service 225 can include management of task accounts for the given geographic region. The task location services 225 can also provide application programming interfaces (APIs) for allowing users to interact with the cloud computing environment. Such APIs can include handling APIs associated with pools of virtual machines, pool management logic, and coordination of pool management logic across task tenants within a given geographic region. The APIs can also include APIs for handling tasks submitted by a user, as well as maintaining, scheduling, and terminating work items or jobs associated with the user tasks. The APIs can further include APIs for statistics collection, aggregation, and reporting for all work items, jobs, tasks, and pools in a geographic region. Additionally, the APIs can include APIs for allowing auction of available virtual machines as preemptible virtual machines to users on a short term basis based on a spot market for virtual machines. The APIs can also include APIs for metering usage and providing billing support.

The task location services 225 can be linked together by a global location service 235. The global location service 235 can be responsible for account creation and management of accounts, including managing task accounts in conjunction with the task location service tenants 225. This includes being responsible for disaster recovery and being responsible for availability of work items and jobs if there is a major data center disaster. This may include running a work item or job in a different location due to a data center not being available for any reason. This can also include allowing customers to migrate their work items, jobs, and pools from one data center to another data center. Typically there will be only one active global location service 235. This active global location service 235 is in communication with the various task location services 225 as well as service components for managing data storage (not shown). The global location service can maintain a global account namespace 237.

As an example of operation of the system in FIG. 2, a hypothetical customer or user 217 can create task account via an interface provided by the global location service 235. In this example, the hypothetical customer is referred to as Sally. The user request to create a task account may optionally specify a geographic region that the account needs to be created in. In this example, Sally requests an account associated with the US North region. In response, the global location service 235 contacts the task location service 225 that corresponds to the requested geographic region (US North) to create the account. If a region is not requested, the task account can be created in a region selected by any convenient method, such as based on a location associated with the requesting user. The global location service 235 also contacts at least another region, such as US South, so that a disaster recovery copy of the account is created. Optionally, Sally could request that US South serve as the failover region for disaster recovery, or US South could be automatically assigned by the system by any convenient method. The task location service 225 maintains all the information for all the accounts in its geographic region. After successfully creating the account in the task location services 225 for US North and US South, the global location service 235 registers the task service endpoint for Sally's account to point to the virtual IP address of the task location service 225 for US North. For example, a domain name service (DNS) record can be created to map a host name such as “sally.task.core.windows.net” to the virtual IP address of the task location service 225 in US North. This completes the creation of the task account for Sally. If a data center disaster occurs at a future time, the global location service 235 can update the DNS record to point to US South.

After the account is created, the customer Sally can access the account and send requests to access the APIs for interacting with the cloud computing environment against the hostname “sally.task.core.windows.net”. For example, Sally can access an API to issue a request to create a new work item or task. A DNS server can then resolve the hostname and the request will be routed to the correct task location service tenant 225. In this example, the request is routed to the task location service tenant 225 for US North, which processes the request and creates the requested work item, job or task.

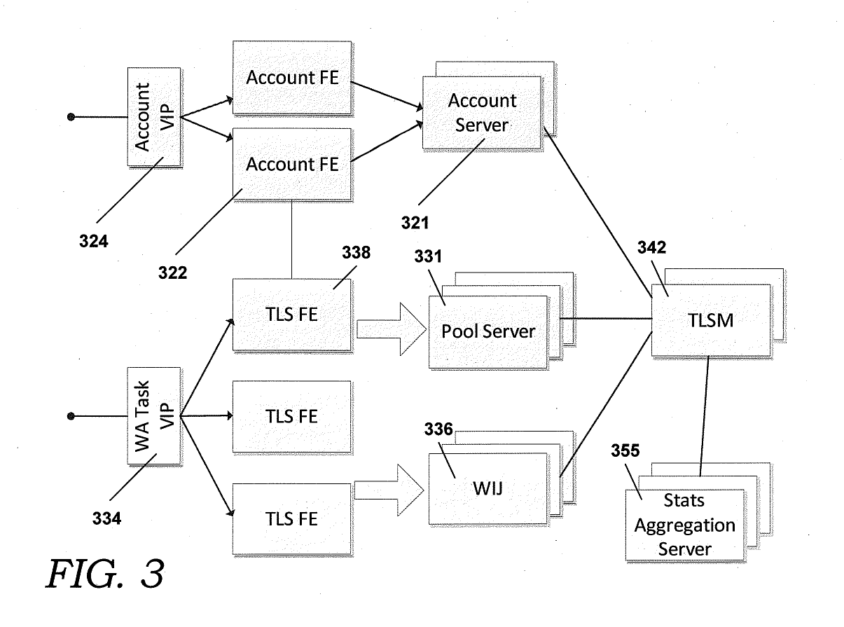

FIG. 3 shows a potential configuration for a task location service. In the configuration shown in FIG. 3, a task location service can include one or more account servers 321. The account servers handle account management for accounts in a given geographic region, including creation, deletion, or property updates. Account front ends 322 serve as the front end nodes for account service. The account front ends 322 are behind an account virtual IP address 324 as shown in the figure. The account front ends 322 process the account API requests coming from global location service, such as API requests to create accounts or delete accounts.

The configuration in FIG. 3 also includes one or more pool servers 331. A pool server 331 handles pool management and pool transactions for pools of virtual machines in a given geographic region. A pool server 331 handles pool creation, deletion and property updates. A pool server 331 also manages the high level virtual machine allocation algorithm across multiple task tenants. Virtual machine allocation can take into consideration the connectivity of a virtual machine with storage for a given user. The pool server may also perform other tasks related to allocation of virtual machines.

The configuration in FIG. 3 also includes one or more work item or job schedulers (WIJ) 336. WIJ schedulers 336 handle creation, deletion, and updates of work items and jobs. In addition, if a user has requested automatic creation and/or destruction of pools when work items or jobs start or finish, the WIJ schedulers 336 may initiate the creation and deletion of pools associated with the work items or jobs. The WIJ schedulers 336 also use generic partitioning mechanisms for scaling. In an embodiment, there are multiple WIJ schedulers 336 in each task location service, and each of the WIJ schedulers handles a range of work items.

The pool servers 331 and WIJ schedulers 336 receive requests from users via task location service front ends 338. The task location service front ends 338 are also responsible for calling corresponding components to process requests from users. The task location service front ends 338 are behind an account virtual IP address 334 as shown in the figure.

The configuration in FIG. 3 further includes a task location service master 342. In an embodiment, the task location service master 342 has two main responsibilities. First, the task location service master 325 serves as a master system for implementing partitioning logic for the corresponding servers in a task location service 225. Additionally, the task location service master 342 can be responsible for computing the new market price for preemptible virtual machines at the beginning of each spot period for the entire geographic region of the task location service. It can collect current bids and resource availability information from the pool servers and task tenants, and computes the new market price accordingly. Alternatively, the task location service master can send the bid and resource availability information to a spot price market service. It also makes high level allocation guidance to pool servers about preemptible virtual machines across all task tenants in a geographic region.

In order to track the activity and behavior of the computing environment, a task location service master 342 can communicate with one or more statistics aggregation servers 355. The statistics aggregation servers are responsible for collecting and aggregating detailed statistics for tasks, jobs, work items and pools. The other components in the system emit fine-grained statistics for tasks and virtual machines. The statistics aggregation servers aggregate these fine-grained statistics from task level or virtual machine level statistics into work item, account level, and/or pool level statistics. The statistics can be exposed for use via an API. In addition, the statistics aggregation servers can be responsible for generating hourly metering records for each account for use in billing.

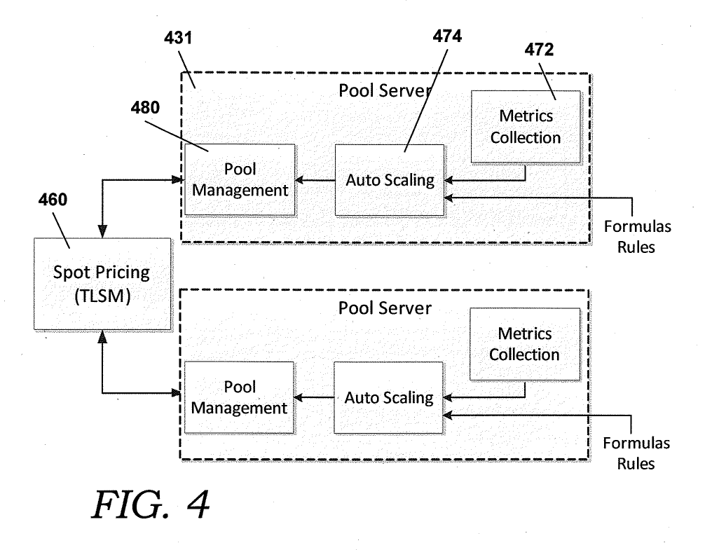

FIG. 4 schematically shows additional modules that can be included as part of a task location service and/or a task location service master. In FIG. 4, spot pricing module 460 is a module that can be part of the task location service master. The spot pricing module is a global module that is responsible for determining the market price at the beginning of each spot period. As a global module, the spot pricing module 460 typically provides information to a plurality of pool servers 431. The spot pricing module 460 maintains heartbeats with pool servers, which are part of a task location service, to synchronize on the current market price for spot priced preemptible virtual machines.

Metric collection module 472 is a module that can be part of the pool server. Metric collection module 472 is responsible for collecting the metrics used for auto scaling for the corresponding pools that a pool server owns. These include the per pool stats of CPU, network, queue stats as well as all the other metrics. The output of this module feeds into the auto scaling module 474. The auto scaling module 474 can also be part of the pool server. The auto scaling module is responsible for making auto-scaling decisions based on the auto-scaling formulas associated with each pool. It takes the metrics along with the formulas/rules provided by the users, and computes the auto scaling actions for each pool. Auto scaling actions can include increasing or decreasing dedicated virtual machines for a pool by a specific amount; increasing or decreasing standby virtual machines for a pool by a specific amount; and increasing or decreasing the target number of spot-priced or preemptible virtual machines for a pool by a specific amount as well as updating the bid price. The output of auto scaling module 474 is fed into pool management module 480, which executes these instructions and otherwise implements the mechanics for changing the size of a given pool. The instructions can be processed in the same manner as a user request for updating the pool size. For a given spot price, the pool management module 480 controls preemption and allocation of preemptible virtual machines in the pools according to the current market price and the outstanding bids.

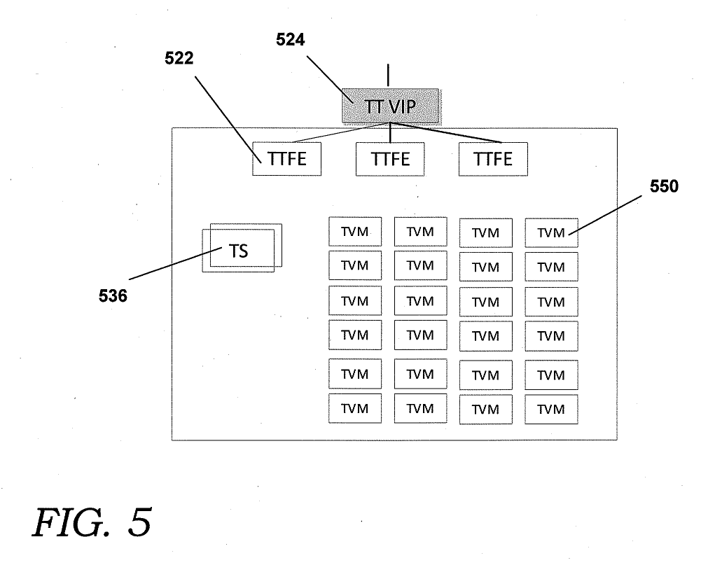

FIG. 5 shows an example high level architecture of an embodiment of a task tenant, including an example of components for a task tenant and the corresponding responsibilities. As noted above, a task tenant can assist with managing pools of virtual machines. In the embodiment shown in FIG. 5, a task tenant includes one or more task tenant front ends 522. The task tenant front ends 522 are behind the task tenant virtual IP address 524 which is internally used for communication between a task tenant and its corresponding task location service, including passing through requests between a task location service and a task tenant.

In the embodiment shown in FIG. 5, the task tenant also includes a task scheduler 536. A task scheduler 536 can be responsible for making local task scheduling decisions within a task tenant. The task scheduler 536 decides what task is to run on each virtual machine it controls. For example, a work item or job submitted by a user can have a set of queues which contain the list of tasks to be scheduled. The task scheduler 536 takes tasks from the set of queues, selects one or more available virtual machines in the pool associated with the job, and contacts the virtual machine(s) to schedule these tasks. The task scheduler 536 can also make scheduling decisions based on priority values associated with jobs. Additionally, the task scheduler 536 keeps track of the virtual machines inside a task tenant. The task scheduler 536 works with pool servers to allocate/deallocate virtual machines to/from pools. In addition, the task scheduler 536 maintains heartbeats with all the virtual machines, synchronizes with the virtual machine about pool membership via heartbeats, and controls restarts/reimage of the virtual machines. Still another function of a task scheduler 536 can be to keep track of the size of the task tenant. Based on the current utilization of the virtual machines within a task tenant, the task scheduler can grow or shrink the task tenant, so that the task tenant has sufficient number of virtual machines to run the tasks associated with the task tenant. Similarly, if there are too many virtual machines sitting idle in the task tenant, the machines can be released for use by other hosted services in the data center.

FIG. 5 also shows a plurality of virtual machines associated with a task tenant. In the embodiment shown in FIG. 5, each of the virtual machines includes task virtual machine agent 550 (TVM). In an embodiment, the task virtual machine agent 550 is responsible for launching tasks on the virtual machine, as well as setting up directories structures and permissions for the tasks. It also configures the operating system firewall on the virtual machine to only allow traffic between virtual machines within the same pool (if the pool needs intra-communication). As discussed earlier, the task scheduler 536 maintains heartbeats with the virtual machines via the task virtual machine agents 550. This allows the task scheduler 536 to monitor the health of the virtual machines as well as synchronizing the pool membership information for the task virtual machine agents.

### Spot Pricing Flow Example

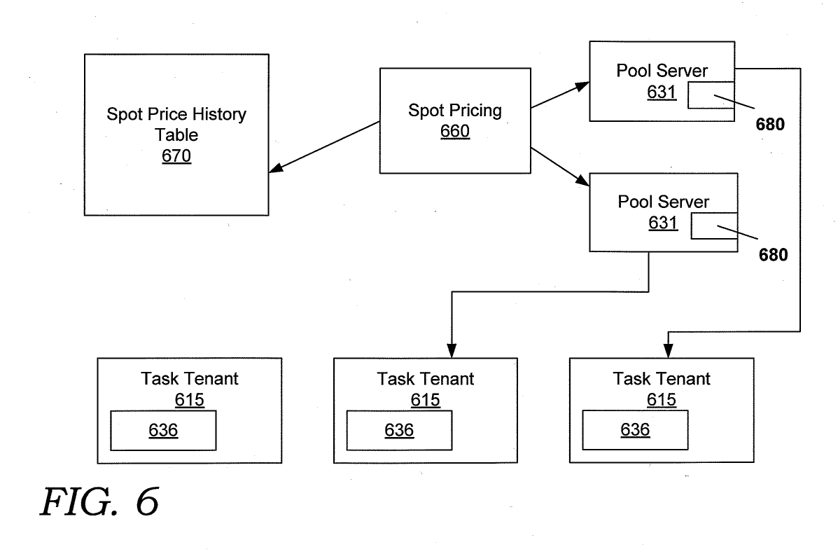

The following provides an example of how spot pricing can be implemented on a global basis within a system. In this example, three components or modules contribute to global spot pricing: a spot pricing module, such as a module within the task location service master or a spot pricing service outside of the task system; a pool management module, such as a pool management module that is part of each pool server in a task location service; and a task scheduler, such as a task scheduler that is potentially a part of each task tenant. The different components have various responsibilities. FIG. 6 schematically shows an example of a system suitable for performing global spot pricing of preemptible virtual machine resources. In the example shown in FIG. 6, updating the global spot price within the cloud computing environment includes at least three processes.

In FIG. 6, the spot pricing module 660 can be responsible for computing a global market price at the beginning of each spot period, such as an assignment time period. The spot pricing module 660 can provide a high level breakdown of spot preemptible virtual machine allocations across all pool servers 631, but the spot pricing module is not involved in detailed allocation decisions for each individual bid. After a market price is determined, the spot pricing module 660 can be responsible for updating a price history table 670 and the pool servers 631. In the example shown in FIG. 6, the price history table 670 corresponds to a global price history table. The price history table 670 can keep track of the market price for each spot period. The spot pricing module 660 can update this table once the price is determined. The spot pricing module 660 can also send market price updates to the pool servers 631 via regular heartbeats between the task location service master and the pool servers. The spot pricing module 660 can also include an initial high level breakdown of spot preemptible virtual machine allocations among different pool servers for each task tenant.

Preferably, the spot pricing module 660 can update the price history table 670 first. The spot pricing module 660 can then update the pool servers 631 via heartbeat messages in a second step. The pool servers then update the various task tenants in a third process. Preferably, price update messages can be tagged with the corresponding timestamp for the spot period. Since the spot pricing module 660 is a global module, the spot pricing module can guarantee that the timestamp always increases. The price history table 670 can always hold the truth of the current spot price. A pool server 631 that is unsure about the current spot price, can access the current spot price via the price history table 670.

The price history table 670 holds the truth of the current price. When a new spot price is set, the spot pricing module 660 will not tell anyone about the new price until the price history table 670 is updated. The task location service master has regular heartbeats with each pool server. Various types of information can be included in each heartbeat message. The heartbeat message can include a timestamp of the current spot period. This timestamp is increasing, and can be used as a sequence number to determine which spot period is more recent. The heartbeat message can also include the market price for the current spot period. Additionally, the heartbeat message can include a time duration until the next spot period will start, which corresponds to when the price is updated again. The pool servers can use this information to decide when they should expect the next price change if they do not hear from task location service master in time.

If the spot pricing module (or the task location service master) is stuck for any reason, the rest of the system can still work correctly, basically extending the current spot pricing through another period. The price table will not be updated and the pool servers will still use the present market price, effectively extending the current spot period. A spot price period preferably has a fixed N minute boundary. For example, if 30 minute periods are used, the periods can be 1:00-1:30, 1:30-2:00, 2:00-2:30, and so on. When the task location service master recovers, it can start a new spot period for the current period if it is within X minutes of a period start time. If it is past X minutes, then it will just wait until the next interval to fix a price. However, in this situation the task location service master can still add to the spot price history table the new spot period with the spot price unchanged. For example, the spot price can be updated if a new spot price is available within a fixed time window, such as the first 5 minutes of the expected start of the current spot period. If the spot pricing module and/or the task location service master is late and misses that time window, the price can be kept unchanged until the next spot period.

Each pool server 631 can include a pool management module 680. The pool management module 632. In this example, the pool management module 680 handles reservation and conversion (between standby virtual machine and dedicated virtual machine) requests within a given pool as well as any explicit request to remove preemptible virtual machines. In addition, to handle spot pricing, the pool management module can be also responsible for fulfilling outstanding bids which are above the current market price and taking away preemptible virtual machines based on bids that no longer qualify. The pool management module 680 can be responsible for tracking the set of pools which have outstanding or unfulfilled bids higher than (or equal to) the current market price. “Outstanding” means pools that have not yet received all the preemptible virtual machines they have asked for. The pool management module can then allocate preemptible virtual machines to fulfill outstanding bids in descending order (i.e. fulfill higher bids first). Additionally, the pool management module can preempt all the preemptible virtual machines from pools that now have bids below the current market price. Note that the pool server 631 is responsible for setting the target number of preemptible virtual machines available in the pool for assignment via spot pricing for a given task tenant 615. Pool server 631 does not track the exact number of preemptible virtual machines allocated in the task tenant 615 for a given pool. It is up to the task tenant 615 to add/remove preemptible virtual machines to reach the target set by the pool server 631.

The task scheduler 636 is a module within a task tenant 615. In this example, the task scheduler 636 does not actively track spot price. The task scheduler 636 can maintain a “TenantPoolTable” or another similar data structure which tracks the target preemptible virtual machine count for each pool in the given tenant. When the task scheduler 636 receives a pool transaction for preemptible virtual machines based on a bid being above (or below) the spot price, the task scheduler will update this table to record the target preemptible virtual machine count for the given pool, and the transaction is completed from the perspective of the pool server 631. The task scheduler is responsible for bringing the preemptible virtual machine count for the pools to the target count. In the case of conversion for dedicated virtual machines, if there are not enough idle virtual machines associated with the task tenant 615, the task scheduler 636 may preempt some of the preemptible virtual machines that have lower bids. This can be done without notifying the pool servers 631 of the preemption.

Allocation and preemption can happen at the beginning of a new spot period as well as during a spot period. At the beginning of a spot period, a task location service master sends each pool server a high level breakdown of preemptible virtual machine allocations among the pool servers across each task tenant. The pool server can use this information to guide allocation and preemption decisions. The pool server tracks all the outstanding bids as well as their submission time. For all the bids submitted before the start of the spot period, or possibly before a cutoff time different from the start of the spot period, the pool server can ensure that higher bids are filled before the lower bids. As a result, some preemptible virtual machines assigned based on lower bids from the previous period may be preempted. Pool servers can also use the global information provided by task location service master to coordinate and minimize unnecessary preemptions.

When the task location service master computes the market price, it will also compute a high level breakdown of the preemptible virtual machine allocation across different pools and different task tenants. This information is passed to all the pool servers to assist their allocation decisions. This information can include a detailed preemptible virtual machine allocation breakdown for each bid price and each constraint for each pool partition range within a task tenant. For example, all the bids with the same bid price and same constraint (e.g. which tenant(s) they need to use due to inter-communication or storage affinity constraints) will be grouped together from the perspective of the task location service master. The task location service master provides a detailed allocation for that group for each pool partition range.

The pool server can compute a fresh allocation (as if all of the potentially preemptible virtual machines are idle) based on the allocation information provided by the task location service master. The pool server can also determine the new target preemptible virtual machine count in each task tenant for each pool. Then the new allocation can be compared against the current allocation to compute the set of pools that need to be updated. The pool server then contacts the related task tenant for the pools that require updating to set the new target values for the number of preemptible machines.

When a pool server allocates preemptible virtual machines, the pool server can start the allocation transactions for the higher bids before trying to allocate anything to the lower bids. The pool server can also track when a bid is submitted. Between two bids of the same price, the earlier bid will take precedence. Note that the pool server does not need to wait for the prior transactions to finish before starting the next ones. Instead, the pool server only needs to ensure that it has started the allocation transaction with the corresponding task tenants before proceeding to the next set of bids. These transactions are preferably performed in parallel.

During an assignment time period, preemption can occur when a virtual machine is needed for assignment as a dedicated machine or when the cloud computing environment needs the machine for another reason such as disaster recovery, a dedicated virtual machine. If there are idle virtual machines available in the system, an idle machine can be used for assignment as a dedicated virtual machine. If additional idle virtual machines are not available, the task tenant can preempt the preemptible virtual machines corresponding to lower bids. Another option for prioritizing machines for preemption is to have a preference for preempting machines that have been running a job for a shorter period of time. Allocation happens when more preemptible virtual machines become available and there are outstanding bids that have not been filled. In that case, the available preemptible virtual machines can be allocated starting with the higher bids.

Preferably, a small set of idle virtual machines can be kept reimaged and ready for use, so that when a virtual machine is needed for dedicated use the dedicated virtual machine can be taken from this set immediately. The task tenants will maintain these idle virtual machines at background. When the number of idle virtual machines in a task tenant drops below a threshold amount, such as 1% of the dedicated virtual machines in the task tenant, the task tenant can start to preempt virtual machines with lower bids until the idle virtual machine count reaches a second threshold, which can be the same or different from the first threshold. The task tenant can preempt these preemptible virtual machines without involving pool servers, allowing this preemption to occur quickly.

On the other hand, if the task scheduler has already fulfilled all its target preemptible virtual machines for all its pools assigned by the pool servers and there are still extra idle virtual machines above the second threshold, the task scheduler can report a count of such extra idle virtual machines to the pool servers via their regular heartbeats. If this count is over a third threshold value, the pool servers will start allocating these extra virtual machines to the outstanding bids.

The following provides a high level example of a process flow for assignment of preemptible virtual machines based on spot pricing. At the start of a spot period, the task location service master (such as the global spot pricing module within the task location service master) computes the new market price for the spot period based on the bids and resource availability. After the price is decided, the task location service master updates the price history table with the new price and a timestamp for the upcoming spot period as described earlier. The task location service master then sends the spot price to each pool server via its regular heartbeat messages. In addition, the task location service master can also send an initial breakdown of the preemptible virtual machine allocation for each pool server. This can help pool servers to make allocation decisions. When a pool server receives a message from the task location service master, the pool server starts to allocate preemptible virtual machines to the outstanding bids for all its pools, as well as preempt all of the preemptible machines that are below the new market price. Specifically, the pool server sends commands to the task tenant to set the new preemptible virtual machine target count on a given pool. This is done the similar way as the pool transaction of setting dedicated virtual machine count, except that the transaction is completed as soon as the task tenant records the target preemptible virtual machine count. Then the task scheduler will try to bring the virtual count to the target by allocating or removing virtual machines from the pool. At the task tenant side, preemptible virtual machine allocation is done the same way as it would for dedicated virtual machines except that the preemptible virtual machines are taken from a global set of idle virtual machines in the tenant and the task scheduler always allocates preemptible virtual machines to the higher bids first. Furthermore, during a spot period, due to resource shortage (e.g. conversion of standby virtual machines into dedicated), the task scheduler may need to preempt preemptible virtual machines. Virtual machines corresponding to pools with lower bids are preempted first in that scenario.

During an assignment time period, a pool server may discover that some preemptible virtual machines have become available for assignment based on spot pricing. For example, some dedicated virtual machines can be converted into standby virtual machines, or some preemptible virtual machines may be released by a user. The pool server can allocate the available virtual machines to the outstanding bids by setting a new (higher) target count for preemptible virtual machines for the given pools, with higher bids taking precedence. In some embodiments, preemptible virtual machines are not allocated towards the end of a spot period, such as in the last 5 minutes of the spot period, since they may be preempted soon when the next spot period starts.

### Examples of Assignment of Virtual Machines in a Cloud Computing Environment

The following hypothetical examples are provided to illustrate the operation and interaction of dedicated, standby, and preemptible virtual machines in a cloud computing environment. In these examples, a small number of virtual machines will be discussed in order to simplify the description and accompanying figures. However, those of skill in the art will recognize that the concepts described here can be scaled up to any desired number of virtual machines.

In the following hypothetical examples, the assignment of various dedicated, standby, and preemptible virtual machines will be described. In the corresponding figures, machines will be labeled as A for user Abel, C for user Charlie, D for user David, and F for user Frank. Some machines will be labeled L to represent an additional large user. In addition to designating the user the virtual machine is assigned to, virtual machines can have a designation (D) for a dedicated machine or (P) for a preemptible machine. The jobs performed by the various users in the examples can be jobs for performing any type of computing, such as performing data mining and management for a business, performing a scientific calculation, or handling retail consumer traffic.

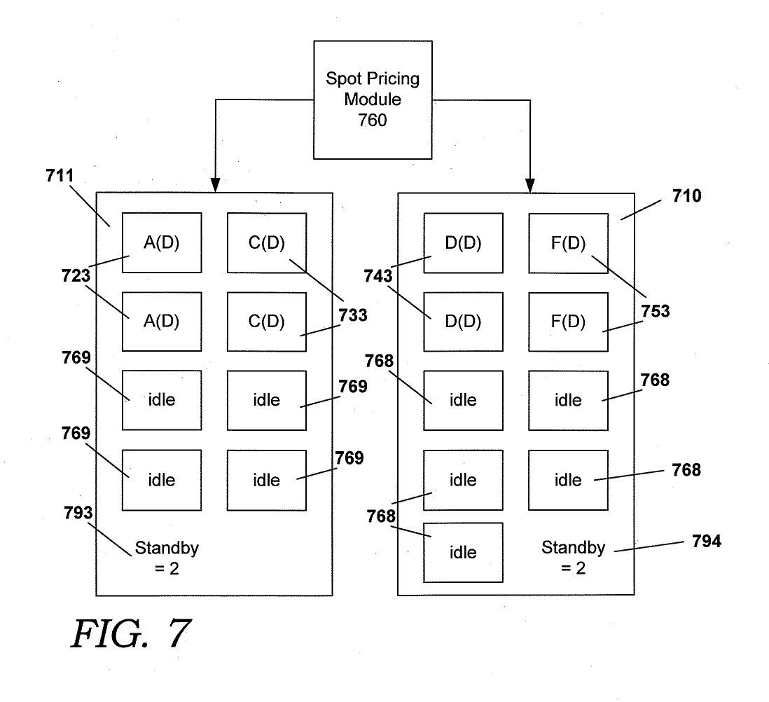

FIG. 7 shows an example of an initial state of the virtual machines in two task tenants 710 and 711. The task tenants are representative, so that any convenient number of task tenants can receive information from a spot pricing module 760. Similarly, the number of virtual machines shown within each task tenant is representative, so that a larger or smaller number of virtual machines can be included within a task tenant. Within a task tenant 710 or 711, each virtual machine with the same starting designation letter corresponds to a machine within the same pool. For example, all of the virtual machines with a “A(?)” format are in a pool associated with the account of user Abel.

In FIG. 7, an initial state of task tenants 710 and 711 is shown prior to assigning any virtual machines as preemptible machines via spot pricing. In FIG. 7, users Abel, Charles, David, and Frank each have two dedicated virtual machines assigned and running jobs. These machines are shown as machines 723, 733, 743, and 753, respectively. Virtual machines 768 and 769 correspond to machines not assigned to any pool. Additionally, a standby count 793 is included below task tenant 710 and a standby count 794 is included below task tenant 711. Standby counts 793 and 794 represent standby virtual machine reservations that are currently associated with the respective task tenants 710 and 711. In FIG. 7, the standby reservations correspond to 2 reservations associated with the large user in each of task tenants 710 and 711. In this example, the standby reservations were associated with the task tenants based on a selection by the system. If the standby reservations were part of an affinity request, the large user could have specified clusters having an appropriate affinity and the standby reservations could have been associated accordingly.

A spot pricing determination is then used to assign preemptible machines to users based on requests from the users. The spot pricing module collects bids provided from all available pools and determines a spot price of 0.6 cents per hour (or other pricing period). Billing can also be performed for fractions of a pricing period. The spot price was based on the various bids for preemptible machines, including the bids from users Abel, Charles, David, and Frank. User Abel requests three preemptible machines with a bid price of 1.5 cents. User Charles requests one preemptible virtual machine with a bid price of 1.3 cents and a second preemptible virtual machine with a bid price of 0.6 cents. User David requests three preemptible machines at a bid price of 0.5 cents. User Frank requests one machine with a bid price of 1.0 cents and another three machines with a bid price of 0.8 cents.

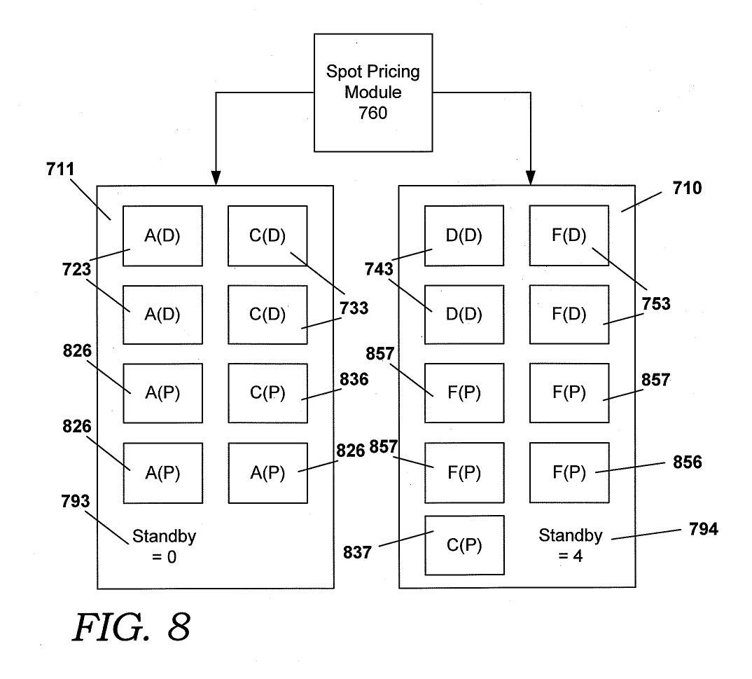

Based on the bids, preemptible machines are assigned to the users. The assignments of the machines to users are shown in FIG. 8. In task tenant 711, three available machines 826 are assigned to Abel, based on having the highest bid for a preemptible machine. These machines correspond to three of the idle machines 769 from FIG. 7. Next, task tenants 710 and 711 attempt to fulfill Charles' request for one preemptible virtual machine at a bid of 1.3 cents. The one available virtual machine 836 in task tenant 711 is assigned to Charles as a preemptible virtual machine.

Next, Frank's bids for virtual machines are addressed sequentially based on bid price. These virtual machines are assigned from task tenant 710, as that is the task tenant with remaining availability. The bid for one preemptible machine at 1.0 cents per time period is fulfilled by virtual machine 856. The bid for an additional three machines at 0.8 cents is fulfilled by virtual machines 857. After assigning virtual machines based on Frank's bids, one virtual machine request from Charles that is at or above the price for the next assignment time period is still unfulfilled. This request is fulfilled by expanding the pool for Charles into task tenant 710 and assigning preemptible virtual machine 837 to Charles. Because the bid associated with David's request is below the spot price for assignment of preemptible virtual machines, David's request for three machines at 0.5 cents is not fulfilled. Based on the above assignments, the preemptible machines with the lowest corresponding bid price are located in task tenant 710. If the large user converts standby reservations into dedicated virtual machines, one option would be to convert two preemptible virtual machines from each of task tenants 710 and 711 to dedicated virtual machines for the large user. This would result in preemptible jobs associated with higher bids in task tenant 711 being displaced. In order to preferentially satisfy higher bids at the expense of lower bids, this could lead to a second displacement so that the higher bid jobs (such as a job for Able) are restarted in task tenant 710 at the expense of jobs with lower bids (such as jobs for Charles or Frank.) Another option is to reallocate the standby reservations across task tenants 710 and 711 so that the standby reservations are associated with task tenants having machines assigned based on the lowest bids. This is shown in FIG. 8, where standby count 793 is adjusted to 0 while standby count 794 is now 4. Note that no machines are reassigned based on the change in the standby account.

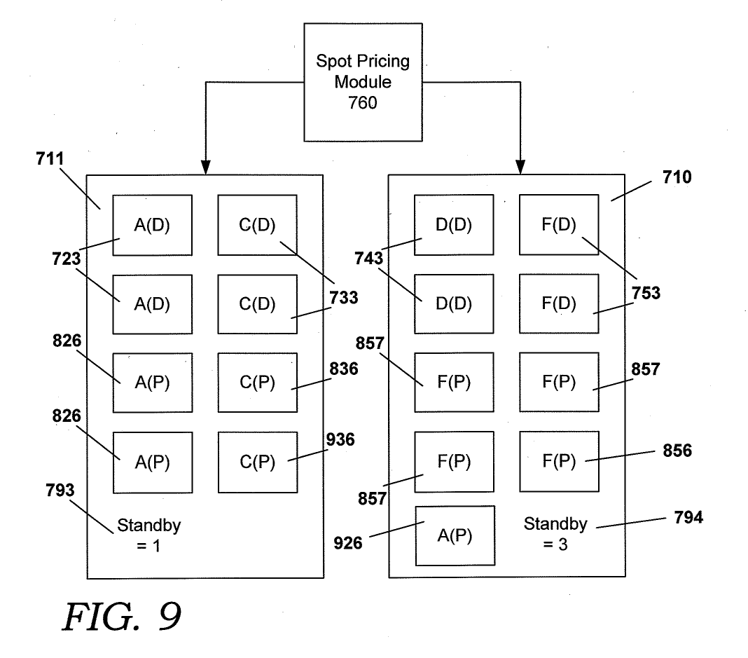

In FIG. 8, an example was used where none of the preemptible bids were based on an affinity request. FIG. 9 shows an alternative example where the preemptible bids from user Charles include an affinity request for the other dedicated or preemptible virtual machines already assigned to Charles. Based on this affinity request, the preemptible job requests from Charles have an affinity for task tenant 711 where Charles has two dedicated virtual machines. In FIG. 9, the same number of virtual machines are assigned to each of users Abel, Charles, and Frank. However, in determining the assignments for virtual machines, the task tenants take into account the affinity request from Charles. If the machines were assigned under the method described in FIG. 8, only one virtual machine would be available for Charles in task tenant 711. Due to the affinity request, Charles would not use a virtual machine from task tenant 710, leaving a request from Charles unfulfilled even though the corresponding bid price is at or above the spot price. To avoid this situation, one preemptible virtual machine 926 is assigned to Abel in task tenant 710. Preemptible virtual machine 936 is then available for assignment to Charles. Even though Abel's bid price is higher than Charles, the affinity request from Charles is considered when fulfilling Abel's request. This allows the utilization and profit from the preemptible machines to be increased. Because the task tenant 711 now includes a preemptible machine assigned at the lowest bid price, the standby count 793 for task tenant 711 is 1 while the standby count for task tenant 710 is 3.

Continuing with the Example shown in FIG. 9, at a later time a trigger event occurs that converts the 4 standby reservations for the large user into dedicated virtual machines. The trigger event could be time-based, load-based due to the activity or usage of the virtual machines being used by the large user, or a combination thereof. In this example, the trigger event is activity or load-based and occurs during the middle of an assignment time period. During this same assignment time period, Abel also increases the number of requested preemptible machines from three to four. The increase request from Abel includes the same bid price.

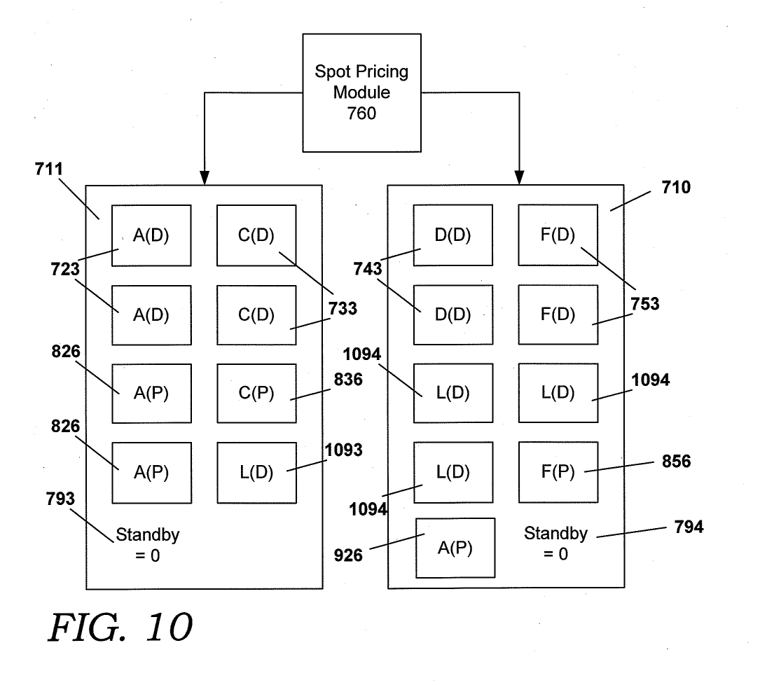

FIG. 10 shows the initial outcome of the above changes. The conversion of standby reservations for the large user results in conversion of virtual machines 1094 to dedicated machines for the large user. The standby reservations are converted to dedicated virtual machines by preempting the lowest priority preemptible jobs. In the example shown in FIG. 10, this corresponds to preempting the jobs with the lowest associated bid. In the example shown in FIG. 10, the standby counts 793 and 794 reflect the task tenants containing the virtual machines assigned based on the lowest preemptible bids, but this is not necessary. As described above, the standby reservations could be associated with a desired task tenant for a variety of reasons, and preemptible jobs could be moved between task tenants after the conversion of dedicated machines. In FIG. 10, the virtual machine corresponding to the lowest preemptible bid was the virtual machine assigned to Charles based on a bid of 0.6 cents. This virtual machine is converted to a dedicated virtual machine 1093 for the large user in task tenant 711. The next three lowest bids correspond to preemptible virtual machines assigned to Frank in task tenant 710. These virtual machines are converted to dedicated virtual machines 1094 assigned to the large user. This leaves one preemptible virtual machine 856 assigned to Frank. Note that although Abel has a higher bid, the spot pricing mechanism is only used to reassign preemptible virtual machines at the beginning of a time period. Since Abel's request was made during the middle of a time period, Abel's request does not displace the virtual preemptible machine assigned to Frank, even though Abel's request includes a higher bid. Additionally, due to the conversion of the standby reservations for the large user, the standby count for both task tenants 710 and 711 is reduced to 0.

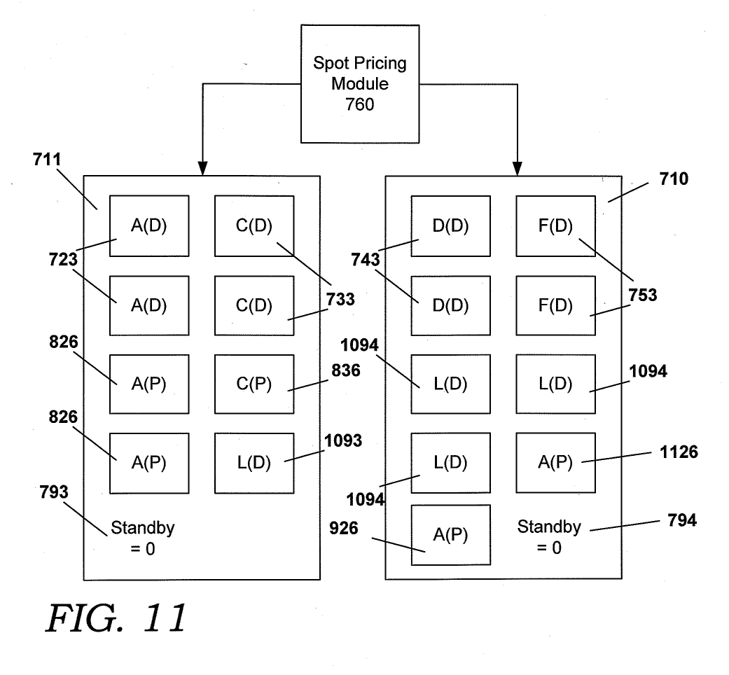

FIG. 11 shows the additional changes that occur at the start of the next assignment time period. Due to the extra resources requested by the large user, fewer virtual machines are available for assignment as preemptible machines. This results in an increase in the global spot price to 11 cents per time period. As shown in FIG. 11, Abel's prior request for an additional machine is now fulfilled by virtual machine 1126. In task tenant 710, the increase in the global spot price causes Frank's bid to fall below the spot price, so Frank is not assigned a preemptible virtual machine during this assignment time period.

### Additional Embodiments

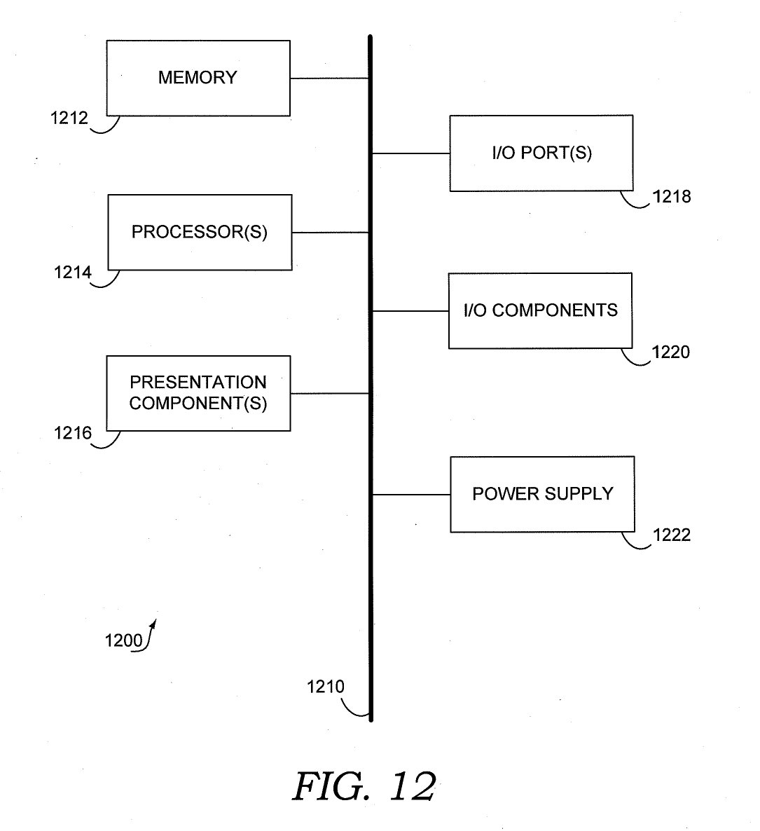

Having briefly described an overview of various embodiments of the invention, an exemplary operating environment suitable for implementing a virtual machine is now described. Referring to the drawings in general, and initially to FIG. 12 in particular, an exemplary operating environment for implementing embodiments of the present invention is shown and designated generally as computing device 1200. Computing device 1200 is but one example of a suitable computing environment and is not intended to suggest any limitation as to the scope of use or functionality of the invention. Neither should the computing device 1200 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, and the like. The invention may also be practiced in distributed computing environments where tasks are performed by remote-processing devices that are linked through a communications network.

With continued reference to FIG. 12, computing device 1200 includes a bus 1210 that directly or indirectly couples the following devices: memory 1212, one or more processors 1214, one or more optional presentation components 1216, input/output (I/O) ports 1218, optional I/O components 1220, and an illustrative power supply 1222. Bus 1210 represents what may be one or more busses (such as an address bus, data bus, or combination thereof). Although the various blocks of FIG. 12 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 12 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 12 and reference to “computing device.”

The computing device 1200 typically includes a variety of computer-readable media. Computer-readable media can be any available media that can be accessed by computing device 1200 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 1200. In an embodiment, the computer storage media can be selected from tangible computer storage media. In another embodiment, the computer storage media can be selected from non-transitory computer storage media.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The memory 1212 can include computer-storage media in the form of volatile and/or nonvolatile memory. The memory may be removable, non-removable, or a combination thereof. Exemplary hardware devices include solid-state memory, hard drives, optical-disc drives, etc. The computing device 1200 includes one or more processors that read data from various entities such as the memory 1212 or the I/O components 1220. The presentation component(s) 1216 present data indications to a user or other device. Exemplary presentation components include a display device, speaker, printing component, vibrating component, and the like.

The I/O ports 1218 can allow the computing device 1200 to be logically coupled to other devices including the I/O components 1220, some of which may be built in. Illustrative components can include a microphone, joystick, game pad, satellite dish, scanner, printer, wireless device, etc.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

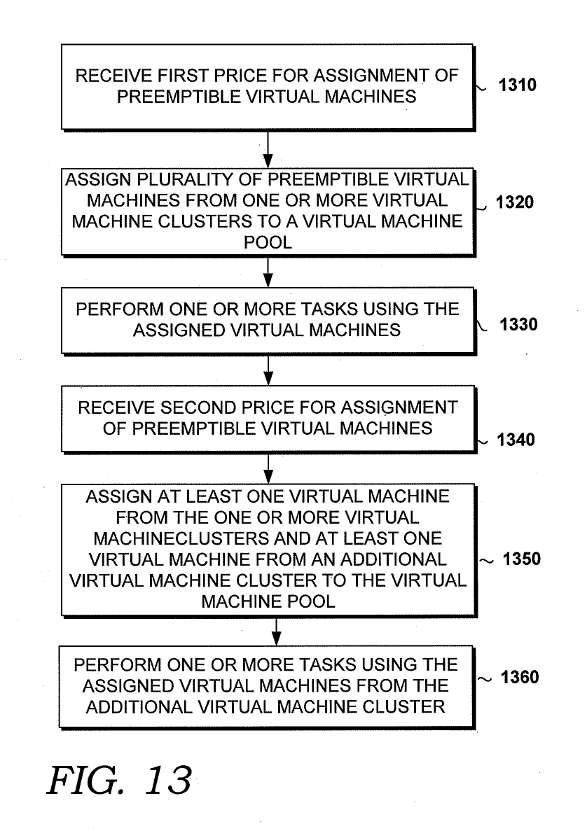

FIG. 13 shows an example of a method according to the invention. In FIG. 13, a first price for assignment of preemptible virtual machines is received 1310. The received price can be used, for example, one or more virtual machine clusters to assign preemptible virtual machines based on the received price and bids associated with various virtual machine pools. A plurality of preemptible virtual machines from one or more virtual machine clusters can then be assigned 1320 to a virtual machine pool. One or more tasks are performed 1330 using the assigned virtual machines. A second price for assignment of preemptible virtual machines is then received 1340. Typically, this can correspond to receiving a new price for use in a subsequent assignment time period. At least one virtual machine from the one or more virtual machine clusters and at least one virtual machine from an additional virtual machine cluster are assigned 1350 to the virtual machine pool. One or more tasks are then performed 1360 using the assigned virtual machine(s) from the additional virtual machine cluster.

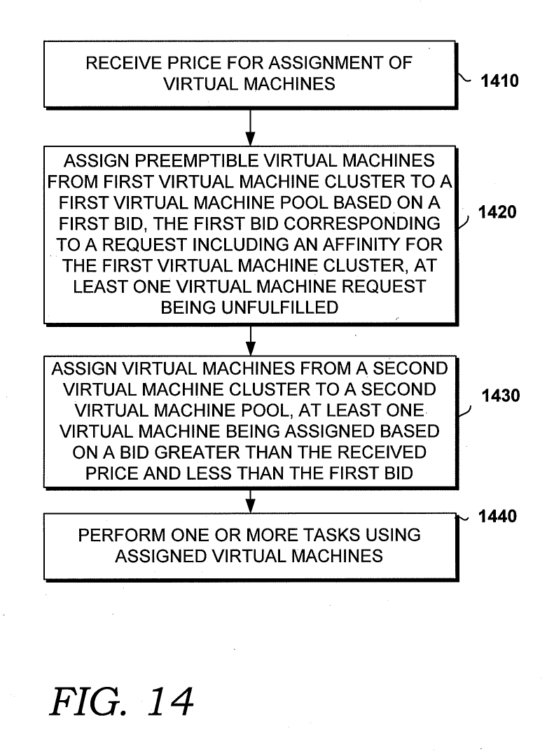

FIG. 14 shows another example of a method according to the invention. In FIG. 14, a price for assignment of preemptible virtual machines is received 1410. Virtual machines from a first virtual machine cluster are assigned 1420 to a first virtual machine pool based on a first bid associated with the first virtual machine pool. The first bid corresponds to a request for virtual machines with an affinity for the first virtual machine cluster. At least one virtual machine in the request is unfulfilled. Virtual machines from a second virtual machine cluster are assigned 1430 to a second virtual machine pool based on a second bid associated with the second virtual machine pool. At least virtual machine assigned to the second virtual machine pool is assigned based on a bid value that is greater than the received price but less than the bid corresponding to the first virtual machine pool. One or more tasks can then be performed 1440 using the assigned preemptible virtual machines, such as the preemptible virtual machines assigned to the second virtual machine pool.

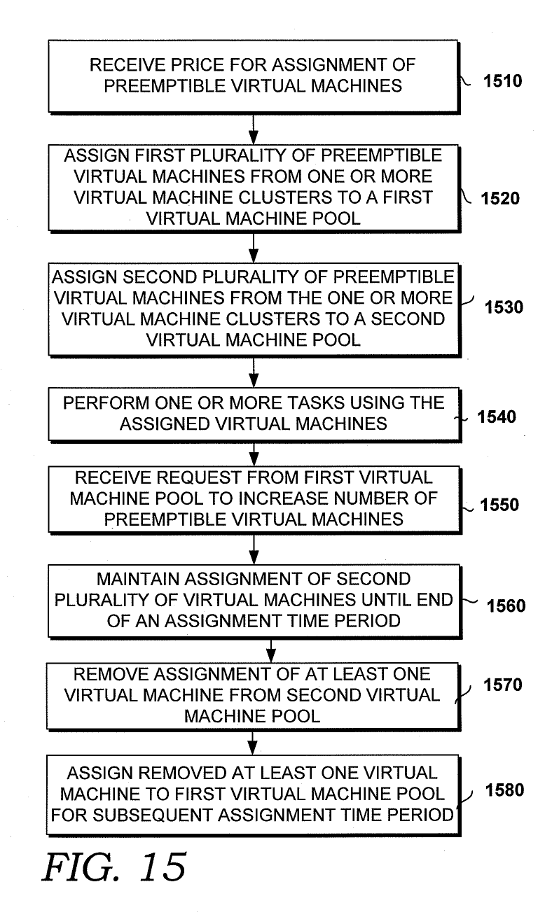

FIG. 15 shows yet another example of a method according to the invention. In FIG. 15, a price for assignment of virtual machines is received 1510.A first plurality of preemptible virtual machines are assigned 1520 to a first virtual machine pool based on an associated first bid. A second plurality of preemptible virtual machines are assigned 1530 to a second virtual machine pool based on an associated second bid. One or more tasks are performed 1540 using the assigned virtual machines. A request is then received 1550 from the first virtual machine pool to increase the number of preemptible virtual machines. The bid corresponding to this request is greater than the bid associated with the second virtual machine pool. The assignment of the second plurality of virtual machines is maintained 1560 until the end of an assignment time period. The assignment of at least one virtual machine from the second plurality of virtual machines from the second virtual machine pool is then removed 1560. The removed at least one virtual machine is assigned 1570 to the first virtual machine pool for a subsequent assignment time period.

In an embodiment, a method for providing resources in a cloud computing environment is provided. The method includes receiving a first price for assignment of preemptible virtual machines; assigning a plurality of preemptible virtual machines from one or more virtual machine clusters to a virtual machine pool based on the received first price and a first bid associated with the virtual machine pool; performing one or more tasks on the assigned plurality of preemptible virtual machines; receiving a second price for assignment of preemptible virtual machines; assigning at least one preemptible virtual machine from the one or more virtual machine clusters and at least one preemptible virtual machine from an additional virtual machine cluster to the virtual machine pool based on the received second price and a second bid associated with the virtual machine pool; and performing one or more tasks on the at least one preemptible virtual machine assigned from the additional machine cluster.

In another embodiment, a method for providing resources in a cloud computing environment is provided. The method includes receiving a price for assignment of preemptible virtual machines; assigning one or more preemptible virtual machines from a first virtual machine cluster to a first virtual machine pool based on the received price and a first bid associated with the first virtual machine pool, the first bid corresponding to a request for a plurality of preemptible virtual machines including an affinity for the first virtual machine cluster, wherein at least one virtual machine in the request for a plurality of preemptible virtual machines is unfulfilled after the assigning of virtual machines in the first virtual machine cluster; assigning one or more preemptible virtual machines from a second virtual machine cluster to a second virtual machine pool based on the received price and a second bid associated with the second virtual machine pool, wherein at least one assigned virtual machine from the second virtual machine cluster is assigned to the second virtual machine pool based on a bid that is greater than the received price and less than the first bid associated with the first virtual machine pool; and performing one or more tasks on the assigned preemptible virtual machines from the second virtual machine cluster in the second virtual machine pool.

In still another embodiment, a method for providing resources in a cloud computing environment is provided. The method includes receiving a price for assignment of preemptible virtual machines; assigning a first plurality of preemptible virtual machines from one or more virtual machine clusters to a first virtual machine pool based on the received price and a first bid associated with the virtual machine pool; assigning a second plurality of preemptible virtual machines from the one or more virtual machine clusters to a second virtual machine pool based on the received price and a second bid associated with the second virtual machine pool; performing one or more tasks on the first plurality of preemptible virtual machines and on the second plurality of preemptible virtual machines; receiving a request from the first virtual machine pool to increase the number of preemptible virtual machines, the increase request corresponding to a third bid associated with the first virtual machine pool, the third bid being greater than the second bid associated with the second virtual machine pool; maintaining the assignment of the second plurality of virtual machines until the end of an assignment time period; removing the assignment of at least one virtual machine from the second plurality of virtual machines from the second virtual machine pool; and assigning the removed at least one virtual machine to the first virtual machine pool for a subsequent assignment time period

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

What is claimed is:

1. A method for providing resources in a cloud computing environment, comprising:
receiving a first price for assignment of preemptible virtual machines;
assigning a plurality of preemptible virtual machines from one or more virtual machine clusters to a virtual machine pool based on the received first price and a first bid associated with the virtual machine pool;
performing one or more tasks on the assigned plurality of preemptible virtual machines;
receiving a second price for assignment of preemptible virtual machines;
assigning at least one preemptible virtual machine from the one or more virtual machine clusters and at least one preemptible virtual machine from an additional virtual machine cluster to the virtual machine pool based on the received second price and a second bid associated with the virtual machine pool; and
performing one or more tasks on the at least one preemptible virtual machine assigned from the additional machine cluster.

2. The method of claim 1, wherein virtual machines from the additional virtual machine cluster correspond to physical machines in a separate geographic location relative to physical machines corresponding to the one or more virtual machine clusters.

3. The method of claim 1, wherein each of the one or more virtual machine clusters correspond to physical machines in separate geographic locations relative to physical machines corresponding to other clusters in the one or more virtual machine clusters.

4. The method of claim 1, wherein the first bid associated with the virtual machine pool and the second bid associated with the virtual machine pool are the same.

5. The method of claim 1, wherein the one or more tasks are performed on the plurality of virtual machines for an assignment time period.

6. The method of claim 1, further comprising assigning at least one virtual machine from the one or more virtual machine clusters to a second virtual machine pool based on a request from the second virtual machine pool, the request including an affinity for a virtual machine cluster in the one or more virtual machine clusters, the assigning of the at least one preemptible virtual machine from an additional virtual machine cluster to the virtual machine pool being responsive to the assigning of at least one virtual machine from the one or more virtual machine clusters to a second virtual machine pool.

7. The method of claim 1, wherein the at least one virtual machine from the one or more virtual machine clusters assigned to the second virtual machine pool is a preemptible virtual machine.

8. The method of claim 1, further comprising:
aggregating bids corresponding to a plurality of virtual machine pools, each bid including a number of requested preemptible virtual machines;
determining a number of virtual machines available for assignment as preemptible virtual machines;
calculating a global spot price based on the aggregated bids, the global spot price being calculated so that the number of requested preemptible virtual machines included with bids greater than the global spot price is less than or equal to the determined number of virtual machines; and
distributing the calculated global spot price to the plurality of virtual machine pools as the price for assignment of preemptible virtual machines.

9. One or more computer-storage media storing computer-useable instructions that, when executed by a computing device, perform a method for providing resources in a cloud computing environment, comprising:
receiving a price for assignment of preemptible virtual machines;
assigning one or more preemptible virtual machines from a first virtual machine cluster to a first virtual machine pool based on the received price and a first bid associated with the first virtual machine pool, the first bid corresponding to a request for a plurality of preemptible virtual machines including an affinity for the first virtual machine cluster, wherein at least one virtual machine in the request for a plurality of preemptible virtual machines is unfulfilled after the assigning of virtual machines in the first virtual machine cluster;
assigning one or more preemptible virtual machines from a second virtual machine cluster to a second virtual machine pool based on the received price and a second bid associated with the second virtual machine pool, wherein at least one assigned virtual machine from the second virtual machine cluster is assigned to the second virtual machine pool based on a bid that is greater than the received price and less than the first bid associated with the first virtual machine pool; and
performing one or more tasks on the assigned preemptible virtual machines from the second virtual machine cluster in the second virtual machine pool.

10. The computer-storage media of claim 7, wherein the first bid comprises a plurality of bid values, the second bid being less than at least one bid value of the first bid.

11. The computer-storage media of claim 7, wherein the first bid comprises a plurality of bid values and the second bid comprises a plurality of bid values, at least one bid value of the first bid being greater than at least one bid value of the second bid.

12. The computer-storage media of claim 7, wherein the at least one unfulfilled virtual machine request remains unfulfilled for an assignment time period, and wherein at least one virtual machine from the second virtual machine cluster is not assigned during the assignment time period.

13. The computer-storage media of claim 7, further comprising:
aggregating bids corresponding to a plurality of virtual machine pools, each bid including a number of requested preemptible virtual machines;
determining a number of virtual machines available for assignment as preemptible virtual machines;
calculating a global spot price based on the aggregated bids, the global spot price being calculated so that the number of requested preemptible virtual machines included with bids greater than the global spot price is less than or equal to the determined number of virtual machines; and
distributing the calculated global spot price to the plurality of virtual machine pools as the price for assignment of preemptible virtual machines.

14. A method for providing resources in a cloud computing environment, comprising:
receiving a price for assignment of preemptible virtual machines;
assigning a first plurality of preemptible virtual machines from one or more virtual machine clusters to a first virtual machine pool based on the received price and a first bid associated with the virtual machine pool;
assigning a second plurality of preemptible virtual machines from the one or more virtual machine clusters to a second virtual machine pool based on the received price and a second bid associated with the second virtual machine pool;
performing one or more tasks on the first plurality of preemptible virtual machines and on the second plurality of preemptible virtual machines;
receiving a request from the first virtual machine pool to increase the number of preemptible virtual machines, the increase request corresponding to a third bid associated with the first virtual machine pool, the third bid being greater than the second bid associated with the second virtual machine pool;
maintaining the assignment of the second plurality of virtual machines until the end of an assignment time period;
removing the assignment of at least one virtual machine from the second plurality of virtual machines from the second virtual machine pool; and
assigning the removed at least one virtual machine to the first virtual machine pool for a subsequent assignment time period.

15. The method of claim 14, wherein the first bid comprises a plurality of bid values and the second bid comprises a plurality of bid values, at least one bid value of the first bid being greater than at least one bid value of the second bid.

16. The method of claim 12, wherein assigning the plurality of virtual machines associated to one or more virtual machine pools as preemptible virtual machines comprises assigning the plurality of virtual machines for an assignment time period.

17. The method of claim 14, wherein assignment of preemptible virtual machines is performed at the beginning of an assignment time period, the price for assignment of preemptible virtual machines being received prior to the beginning of an assignment time period.

18. The method of claim 17, wherein the assignment time periods are consecutive.

19. The method of claim 17, wherein a day is divided into a plurality of assignment time periods, the assignment of preemptible virtual machines being performed for each assignment time period.

20. The method of claim 17, wherein the increase of the number of preemptible virtual machines is requested by the first virtual machine pool after the price for assignment of preemptible virtual machines is received but prior to the beginning of the subsequent assignment time period.
